(19) United States
(12) Patent Application Publication
(10) Pub. No.: US 2018/0327217 A1
(43) Pub. Date: Nov. 15, 2018

(54) ELEVATOR SYSTEM

(71) Applicants: ThyssenKrupp Elevator AG, Essen (DE); ThyssenKrupp AG, Essen (DE)

(72) Inventor: Oliver Dräger, Reutlingen (DE)

(73) Assignees: ThyssenKrupp Elevator AG, Essen (DE); ThyssenKrupp AG, Essen (DE)

(21) Appl. No.: 15/529,985

(22) PCT Filed: Nov. 13, 2015
(86) PCT No.: PCT/EP2015/076541

§ 371 Date: May 25, 2017

(30) Foreign Application Priority Data
Nov. 26, 2014 (DE) 10 2014 117 373.2

(51) Int. Cl. B66B 3/00; B66B 9/00

(52) U.S. Cl. CPC B66B 3/002; B66B 9/003

(57) ABSTRACT

The disclosure relates to an elevator system and a method for operating such an elevator system. The elevator system has a cabin and a first and a second transport path for the cabin. The direction of the first transport path differs from that of the second transport path. A signaling device is located in or on the cabin, which displays a change of the cabin from the first transport path into the second transport path and/or vice versa.

### FIELD

The present invention relates to an elevator system having a cabin and a first and a second transport path for said cabin, wherein the direction of the first transport path differs from that of the second transport path, and to a method for operating such an elevator system.

### BACKGROUND

Elevator systems that have differing transport paths for a cabin usually have more than one shaft. A cabin is transported, for example, in circulating operation between two shafts. Transfer devices transport a cabin, over a minimum of two floors, from one shaft to the other. Such transfer devices are usually utilized in elevator systems that have more than two cabins and in which traffic circulates between two shafts. Systems in which a cabin is (temporarily) parked in a different shaft by means of a transfer device are also known.

To achieve a sufficient carrying capacity of the overall system in said elevator systems, which have at least two cabins and at least two shafts, cabins must occasionally travel horizontally at velocities, for instance, when transferring a cabin from one shaft into another, which would present a risk of injury to people present in the cabin. This risk of injury lies within the scope of typical accelerations of cabins as well as increased acceleration during emergency braking. In as far as the transport of persons during a change in the transport path is not specifically intended, in particular horizontal transport, this is undesirable and to be avoided. Nevertheless, there is a residual possibility of persons remaining in the cabin, mistakenly or due to misuse, and subsequently being at risk of injury during the transport path change, particularly during horizontal travel.

It is therefore desirable to provide an elevator system and a method for operating such an elevator system to minimize the risk of injury when persons remain in a cabin of the elevator system during a change in transport path, in particular during horizontal travel.

### SUMMARY

According to the disclosure, an elevator system is proposed having the features of claim 1, and a method for operating an elevator system having the features of claim 10. Advantageous configurations are the subject matter of the dependent claims and described hereafter.

An elevator system according to the invention comprises a cabin and a first and a second transport path for said cabin, wherein the direction of the first transport path differs from that of the second transport path. The first transport path comprises, in particular, a vertical direction, and the second transport path, in particular, a horizontal direction. In the cabin and/or on the cabin a signaling device is located, which displays a change, in particular an upcoming change, of the cabin from the first transport path into the second transport path and/or vice versa. In the aforementioned exemplary case a change from the vertical direction to the horizontal direction, and/or a change from the horizontal direction to the vertical direction displayed to a person in the cabin, is by means of a signaling device located in or on the cabin.

In a corresponding method according to the invention for operating an elevator system having a cabin, which is moved along a first and a second transport path for said cabin, wherein the direction of the first transport path differs from that of the second transport path, a change of the cabin, in particular an upcoming change, from the first transport path into the second transport path, and/or vice versa is indicated by means of a signal.

The signal indicating the transport path change allows a person in the cabin to stabilize their position and, in particular, to prepare themselves for an upcoming transport path change.

In this context, it should be stressed that the use of indefinite articles, for instance as in “a cabin”, “a transport path” or “a signaling device”, does not denote “one single”, but rather an indefinite number, in other words expressing “one or a plurality of”.

It is advantageous if the signaling device or the signaling devices generate optical and/or acoustic signals. In this way a person can be notified by means of their auditory and/or visual sense.

It is also advantageous if an optical signal is output that indicates the direction of at least one of the transport paths. For example, the respective direction of the transport path of a cabin can be displayed by means of an illuminated arrow in the cabin, wherein, in the event of a change in the direction of transport, for example, an additional acoustic signal sounds.

It is, in particular, advantageous if a change of the transport paths is displayed for a specified period of time period before the change in direction taking place. For example, a signal can be output to this end which indicates a change in direction, for instance a blinking red arrow indicating the direction of the next transport path. Preferably the remaining time period before the actual change of transport paths should be approximately the same as, or at least equal to, the average response time of a person in the cabin. In this way there is sufficient time left for the person to stabilize their position. On the other hand, it is advantageous to limit the time period to the time that the cabin requires to travel between two stops of the elevator system, in particular to travel between the last stop before the transport path change and the stop at which the transport path change occurs. In this way, a person in the cabin is therefore shown the transport path change during the travel to the stop at which the transport path change occurs.

As has been mentioned several times, the invention is particularly advantageous when used for elevator systems in which the direction of the first transport path runs vertically and the direction of the second transport path runs horizontally. An exchange of the first and second transport path is of course possible, so that the first transport path runs horizontally and the second transport path runs vertically. Naturally, any other possible directions of the transport paths are also conceivable.

A second aspect of the present invention relates to the determination of a maximum velocity and/or a maximum acceleration of the cabin after a transport path change. This aspect is described hereafter without loss of generality in connection with the previously described signal indicating a change in the transport path direction. However, the right is reserved to independently seek protection for this aspect of the invention.

In accordance with this second aspect of the invention, the maximum velocity and/or the maximum acceleration of the cabin immediately after a change in the transport paths is limited to a predefined value. This measure, alone or in addition to the output of a signal as described in detail above, can, in the event of a transport path change, aid a person to sufficiently stabilize their stance or position in order to minimize a risk of injury.

The value of the maximum velocity of a cabin after a transport path change is advantageously determined as follows: it is assumed that, in the interest of their own stability, a person standing in a moving cabin occupies a certain area of the cabin floor, which is primarily characterized by the distance D between the central points of the soles of their feet. In the absence of external influences, a person adopts the position of the center of gravity, as a rule, approximately mid-way along the line connecting the central points of the soles of their feet, i.e. midway along the span between their feet. If a person is subjected to an external influence, such as a change of transport paths, a risk of injury is minimized provided this center of gravity is within the span between their feet, or in other words within the imaginary line connecting the central points of the soles of their feet. If the center of gravity leaves the said region, a risk of injury from falling onto, or collision with, the cabin wall or similar is high.

The choice of a sufficiently low target velocity Vₘₐₓ can have the effect of allowing a person in an average state of alertness and in the aforementioned described stance to be able to maintain their stability in the event of a fairly large acceleration by transferring their weight to one foot or the other in a timely manner. For safety reasons, it is assumed that accelerations can vary arbitrarily, i.e. that acceleration could occur instantly from 0 to the target velocity and vice versa. The scenario considered here is particularly relevant in the event of an emergency stop, in particular in the horizontal transport path direction. At such times the person and the cabin have a relative velocity close to the target velocity. For a person to maintain their stability, it is sufficient that during the average response time T the center of gravity of their body does not move outside of the aforementioned span between their feet. The distance travelled by the center of gravity relative to the cabin is given by S=V·T. To maintain stability, V must be ≥(D/2)/T and therefore Vₘₐₓ=D/(2T).

Assuming, for example, a width of a person's stance, or a span between their feet of D=500 mm and an average response time of T=1 s, a maximum velocity Vₘₐₓ=0.25 m/s results.

In the example above, the maximum velocity can therefore be compensated for, for example in the event of emergency braking, by a person transferring their weight, with no increased risk of injury.

In general, a method involving graded jolting braking and also (positive) acceleration is conceivable. Since when traveling at a steady velocity no other forces act on a person, in principle a renewed acceleration/deceleration can be performed after a certain time period. This time period until a fresh acceleration/deceleration is the additional time that a person requires to move from their just about stable position, for example on one foot, back into the central position of the center of gravity, in which their weight is evenly distributed over both feet with maximum stability. Only then do comparable initial conditions again exist before the beginning of a subsequent acceleration/deceleration process as before the beginning of the first acceleration/deceleration process. Since the first time T was defined by the human response to the event “braking start”, it can be assumed that the additional event “standstill relative to the cabin” in turn requires the same time T for the person to bring their center of gravity back into the center between both points of the soles of their feet. For a single braking the time is irrelevant, since it does not result in any additional restriction of the maximum velocity. For a multi-stage braking, however, it is relevant, because as already stated comparable initial conditions must prevail before every braking stage if the relevant arguments for the velocity difference are to hold.

Instead of such a staged braking, which is without doubt relatively uncomfortable for the person in the elevator, a continuous braking with a finite acceleration a can now also be carried out with the same end result. A more detailed consideration of the continuous braking (or corresponding acceleration) is useful in cases in which, contrary to the previous assumptions, the braking does not occur substantially faster than the response time of the person (i.e. it is not emergency braking). Then there is no need to specify a maximum velocity, but rather a maximum acceleration aₘₐₓ. As this acceleration in accordance with the assumptions at the same time represents the relative acceleration of the person relative to the cabin, the result obtained for the integral of the velocity, i.e. the path, is simply the well-known formula for motion under constant acceleration:

$${s}_{ma x} = \frac{1}{2} {a}_{m a x} {T}^{2}$$

and, since sₘₐₓ is half the distance between the feet, as before, the maximum acceleration is given by

$$= \frac{D}{{T}^{2}}$$

$${a}_{m a x} = \frac{2 {s}_{m ax}}{{T}^{2}}$$

The present invention also relates—as explained previously—to a corresponding method for operating an elevator system according to the invention, wherein reference is made here in full to the statements made in relation to the elevator system according to the invention, in order to avoid repetition.

It goes without saying that the aforementioned features and those yet to be explained below can be applied not only in the respectively specified combination, but also in other combinations or in isolation without departing from the scope of the present invention.

The invention is shown schematically in the drawing by reference to an exemplary embodiment and is described in detail in the following with reference to the drawing.

### DESCRIPTION OF THE FIGURES

FIG. 1 shows a schematic representation of an elevator system having two cabins and a transfer device for transferring a cabin from one shaft into the other shaft of the elevator system,

FIG. 2 shows a stable position of a person in a cabin of the elevator system in a schematic view,

FIG. 3 shows a diagram for a staged braking of an elevator cabin and

FIG. 4 shows a diagram of a continuous braking of an elevator cabin.

### DETAILED DESCRIPTION

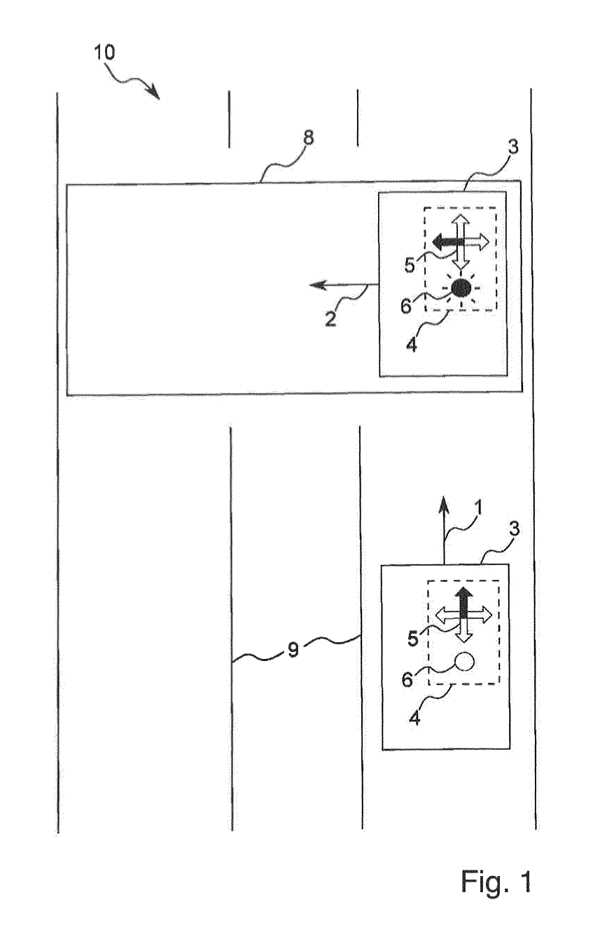

FIG. 1 shows a schematic diagram of two shafts 9 of an elevator system, for example a multi-cabin system having at least two cabins in circulating operation. A transfer device 8, here only shown schematically, adopts the transportation of a cabin 3 from one shaft into the other shaft. A further transfer device 8 is present but not shown here. The cabins 3 that are shown can be different cabins. FIG. 1 can also be understood, however, as showing snapshots of a cabin 3 in the elevator system 10 taken at various times.

In a cabin 3, a signaling device 4 is located, not drawn to scale, which indicates a change of the cabin 3 from a first transport path 1, here in the vertical direction, into the second transport path 2, here in the horizontal direction. It is advantageous in this exemplary embodiment if the signaling device also indicates a change from the second transport path 2 into the first transport path 1, for example after passing through the transfer device 8.

The signaling device in this exemplary embodiment comprises two optical signals 5 and 6. The optical signal 5 shows the direction of the respective transport path 1 or 2. There are therefore four direction arrows provided, by means of which the respective vertical or horizontal direction can be indicated. In the exemplary embodiment presented according to FIG. 1, the optical signal 5 of the lower cabin 3 indicates the direction of the transport path 1 directed upwards, for example colored green. The optical signal 6 in this embodiment is, for example, not activated in this state.

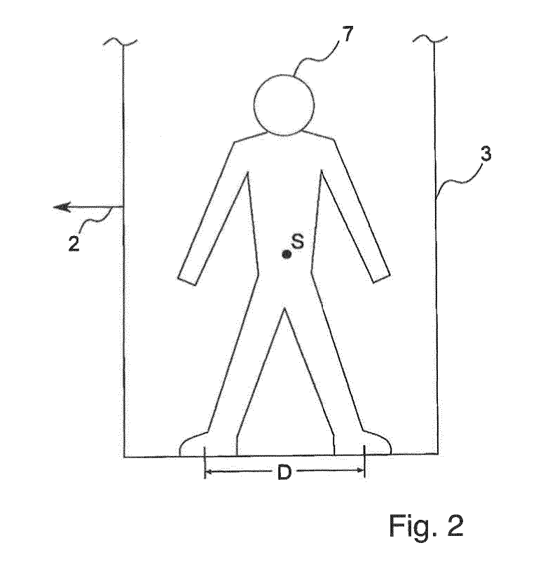

In the event of a change of the cabin from the first transport path 1 to the second transport path 2, the optical signal 5 indicates the corresponding direction of the transport path 2, for example in red. In this exemplary embodiment, the optical signal 6, for example a red flashing light, is additionally activated. In addition, an acoustic signal can also sound when the optical signal 6 is active. The change of direction associated with the change of the transport paths is therefore signaled to a person 7 located in the cabin 3 (cf. FIG. 2), so that said person can adopt a stable position, in order to minimize their risk of injury.

To this end it is particularly advantageous if the optical signals 5 and/or 6 are activated in the described manner a predefined time period before the actual change of direction. For example, the optical signal 6 can already be activated during this predefined time period in order to signal the upcoming change of direction to a person 7. In addition to the upwardly directed green arrow, for example, of the signal 5 indicating the direction, the upcoming change of direction can also be signaled to a user 7, for example, by means of an additionally red flashing arrow, which points in the direction of the transport path 2. It is advantageous if the time period referred to is at least the average response time of persons 7 using the elevator system 10. Such average response times are known per se. The specified time period can also be selected to be larger, so that the direction change signal is indicated even before the transfer device 8 becomes active. This can be effected, for example, on the journey from the previous stop to the stop of the transfer device 8.

FIG. 2 shows a highly schematic and not-to-scale diagram of a person 7, located in a cabin 3 of the elevator system 10 shown in FIG. 1. During a normal elevator ride, for example in the direction of the transport path 1 (compare FIG. 1), the person 7 occupies a certain standing area of the cabin floor, which can be characterized by the distance D between the central points of the soles of the feet. The position of the person 7 shown is selected for maximum stability. The center of gravity S of this person 7 is located approximately centrally above the imaginary line connecting the central points of the soles of the feet.

In the event of an external influence, in particularly in the case of an acceleration of the cabin 3 in the direction of the transport path 2 shown in FIG. 2, a change will first occur in the location of the center of gravity S, until a stable position is occupied again. As long as the center of gravity S moves over the imaginary line connecting the central points of the soles of the feet, it can be assumed that only a minimal risk of injury due to a fall or collision with the cabin wall exists. In order for a person 7 to remain with their center of gravity S within the imaginary line connecting the central points of the soles of the feet within the average response time T after a change in the transport path directions, the following equation for the maximum velocity of the cabin 3 must hold after a change of direction: Vₘₐₓ=D/(2T). For an average stance width of D=500 mm and T=1 s, a maximum velocity Vₘₐₓ=0.25 m/s is therefore obtained. As already pointed out, the considerations apply in particular in the event of an emergency braking, in which the cabin is braked from Vₘₐₓ to 0 in the shortest possible time.

It is advantageous if the elevator system 10, or the transfer device 8, contains a control device that limits the transport velocity of the cabin 3 on the relevant transport path 2 according to the above statements. In this context it should be stressed that under certain circumstances, the described measure for the velocity limitation can even be sufficient to minimize the risk of injury without the additional signaling described in accordance with FIG. 1 being necessary.

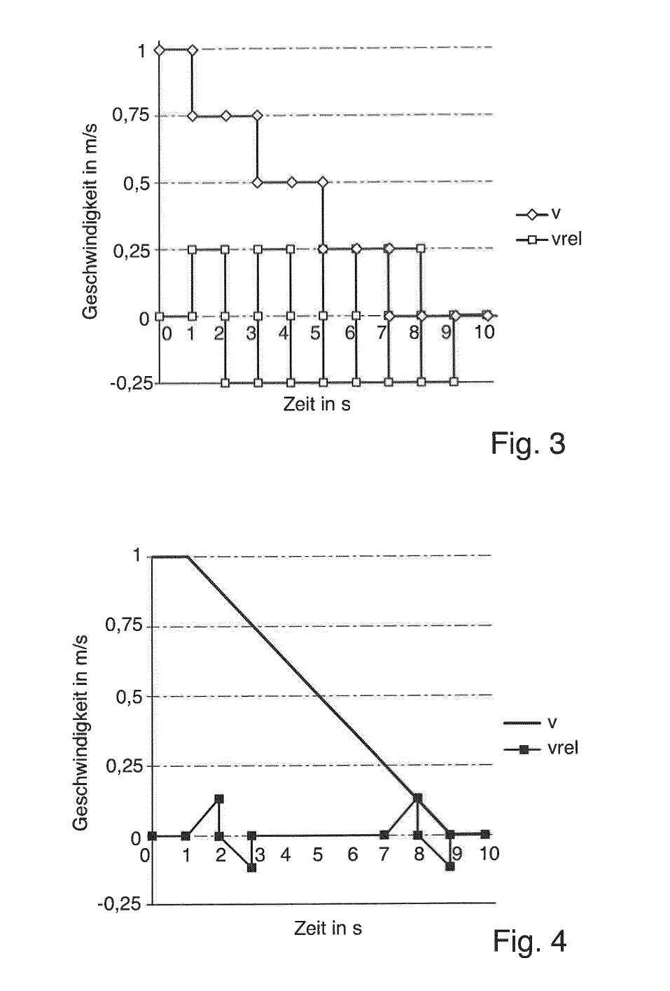

FIG. 3 shows a multi-stage braking, as has already been described above, wherein the absolute velocity v of the cabin and the relative velocity vrel of a person relative to the cabin is plotted against time.

At time t=1 s the first braking of the cabin by Δv=−vmax=−0.25 m/s is performed (curve with diamond-shaped dots), so that the person now has a relative velocity with respect to the cabin of vrel=+vmax (curve with square dots). After the response time T=1 s (at t=2 s) the person has just reached the limit of their stability at the relative position D/2 and the relative velocity immediately slows down to vrel=0 just in time. Immediately however, the person also begins to regulate their position back to the central position, which takes T=1 s (until t=3 s) to complete, and therefore because of the same path must also take place with the same velocity vrel=−vmax. There the person immediately slows back down to vrel=0, and comes to rest there for a moment with their center of gravity in the middle between the two feet. But now, since the next stage of the braking begins, the regulation process of the person starts again. The integral under the curve vrel is zero, indicating that the relative distance between the cabin and the person ends up as zero, and so on average the person has not moved relative to the cabin.

Instead of the aforementioned staged braking, a continuous braking with a finite acceleration a can be carried out with the same end result. For the case whereby this acceleration is selected such that it corresponds to the entire velocity change and to the entire duration of the multi-stage braking, the diagram of FIG. 4 is obtained. In this case it was again assumed for simplicity that the person can react to the events “edge position reached” and “center position reached” with a velocity jump. In addition, the analysis here ignores the fact that during the deceleration phase the person chooses a position for their center of gravity which is somewhat close to the center, in order to optimally compensate for the slightly modified resultant force. Since the relevant displacement for horizontal accelerations that are much smaller than the acceleration due to gravity is very small, this approximation is reliably justified for typical braking.

Under these assumptions, it is again found that the integral of the relative velocity at the beginning, at the end and also of course over the entire process is in each case zero, which therefore takes account of the fact that each time the center of gravity of the person returns to the central position.

It is striking that in spite of the same average acceleration as in the case of staged braking, in both cases the relative velocities are smaller and the areas/integrals under the relative velocity curve are smaller, and therefore so are the relative paths. Thus, at the reversing position of the movement of the person the stability limit (tipping over on one foot) is not even reached. Rather the situation is that, compared to a staged braking, the continuous braking described represents a much more favorable case, since substantially higher mean decelerations can be selected before the person is forced to the stability limit.

As already explained above, the resulting value for the maximum acceleration aₘₐₓ is:

$${a}_{m a x} = \frac{D}{{T}^{2}} .$$

### LIST OF REFERENCE NUMERALS

1 first transport path

2 second transport path

3 cabin

4 signaling device

5 optical signal

6 optical signal

7 person

8 Transfer device

9 shaft

10 Elevator system
T average response time
D average stance width
S center of gravity

1. An elevator system comprising: a cabin having a first and a second transport path, wherein a direction of the first transport path differs from that of the second transport path; and
a signaling device one of in and on the cabin, which displays a change of the cabin from one of the first transport path and the second transport path to the other of the first transport path and the second transport path.

2. The elevator system as claimed in claim 1, wherein the signaling device is a signaling device for at least one of optical and acoustic signals.

3. The elevator system as claimed in claim 2 wherein the signaling device indicates an optical signal displaying at least one of the transport paths.

4. The elevator system as claimed in claim 1, wherein the signaling device indicates the change of the transport paths for a specified time period before the change of direction taking place.

5. The elevator system as claimed in claim 4, wherein the specified time period is at least equal to an average response time (T) of a person in the cabin.

6. The elevator system as claimed in claim 4, wherein the specified time period is no greater than the time that the cabin requires to travel between two stops of the elevator system.

7. The elevator system as claimed in claim 1, wherein the direction of the first transport path runs vertically and the direction of the second transport path runs horizontally.

8. A method for operating an elevator system having a cabin, which is moved along a first and a second transport path, wherein the direction of the first transport path differs from that of the second transport path, the method comprising:
determining a change of the cabin from one of the first transport path and the second transport path to the other of the first transport path and the second transport path; and
operating a signaling device based on the determination.

9. The method as claimed in claim 8, further comprising:
indicating the transport paths for a specified time period before the change of direction taking place.

10. The method as claimed in claim 9, wherein the specified time period is at least equal to an average response time (T) of persons using the elevator system.

11. The method as claimed in claim 10, wherein the specified time period is no greater than the time that the cabin requires to travel between two stops of the elevator system.

12. The method as claimed in claim 11, wherein the maximum velocity of the cabin is limited to a predetermined value (Vₘₐₓ).

13. The method as claimed in claim 12, wherein the predetermined value of the maximum velocity (Vₘₐₓ) is approximately D/(2T), where D is an average stance width and T is an average response time of persons using the elevator system.

14. The method as claimed in claim 13, wherein a maximum acceleration of the cabin is limited to a predetermined value (aₘₐₓ).

15. The method as claimed in claim 14, wherein the predetermined value of the maximum acceleration (aₘₐₓ) is D/T².
